(19) United States
(12) Patent Application Publication
(10) Pub. No.: US 2004/0126558 A1
(43) Pub. Date: Jul. 1, 2004

(54) Composite sponge foam

(76) Inventors: Lendell J. Williams, St. Charles, MI (US); Phil Sheridan, Saginaw, MI (US)

Correspondence Address: WARN, BURGESS & HOFFMANN, PC, PO BOX 70098, ROCHESTER HILLS, MI, 48307, US

(21) Appl. No.: 10/684,247

(22) Filed: Oct. 9, 2003

Related U.S. Application Data
(60) Provisional application No. 60/418,108, filed on Oct. 11, 2002.

(51) Int. Cl. B32B 3/26; B32B 3/06; B32B 9/00

(52) U.S. Cl. 428/304.4; 428/306.6; 428/318.4

(57) ABSTRACT

A cellular foam product is described, wherein the foam includes a polyurethane foam base, having a latex rubber coating on the exterior surface and slightly penetrating the foam interior such that the foam porosity is preferably maintained. The foam has applications in fruit and vegetable sponge drying donuts, the foam allows for uptake of water during fruit drying, while the latex exterior adds to durability. The latex is formulated to include hydrophilic characteristics to aid in water uptake/absorption.

### CROSS-REFERENCE TO RELATED APPLICATION

The instant application claims priority to U.S. Provisional Patent Application Serial No. 60/418,108, filed Oct. 11, 2002, the entire specification of which is expressly incorporated herein by reference.

### FIELD OF THE INVENTION

The present invention generally relates cellular foam products, and more specifically to those cellular foam products that contain a latex rubber, natural rubber, styrene/butadiene rubber (SBR), nitrile butadiene rubber (NBR) or other compositions, preferably impregnated through the porous structure of the foam.

### BACKGROUND OF THE INVENTION

Cellular foam products, most notably polyurethane foam products have been used in a wide range of applications ranging from cushioning, clothing liners, padding, medical sponges, insulation, and the like. Latex foam rubber, either cellular and/or non-cellular, has also had a wide range of applications, including use as bedding, carpet underlayment, cushioning, and applicator pads.

Both polyurethane foam and latex rubber have been separately and individually used in sponge “donuts” to aid in drying vegetable and fruit products, without damaging them, as might occur if a more rigid substrate was used. These sponge donuts are typically placed on a rotatable shaft and subsequently contact the fruits and vegetables after they are washed. The sponge donuts rotate on a shaft and serve to dry the produce as well as move it to the end of the machine, e.g., for further processing and/or packaging.

Current polyurethane foam donuts provide an inexpensive, replaceable alternative, while current latex rubber donuts offer durability. These latex donuts are often “foamed” by mechanically whipping or frothing air into a liquid latex emulsion, then dried and oven cured to produce a rigid cellular, or porous structure for the purpose of water uptake.

Accordingly, there exists a need for a new sponge donut, and method for making the same, that is relatively inexpensive and durable, while at the same time being substantially effective with respect to water uptake.

### SUMMARY OF THE INVENTION

One embodiment of the present invention provides a composite structure comprising polyurethane foam that includes a latex layer.

A method of manufacturing a composite structure is also provided. The method comprises the steps of creating a foam base and forming a latex coating thereon.

In accordance with a first embodiment of the present invention, a composite structure is provided, comprising: (1) a polymeric foam substrate; and (2) a latex layer formed on at least a portion of a surface of the polymeric foam substrate, wherein the latex layer infiltrates into at least a portion of a subsurface layer of the polymeric foam substrate.

In accordance with a second embodiment of the present invention, a composite structure is provided, comprising: (1) a polymeric foam substrate; and (2) a latex layer disposed on at least a portion of a surface of the polymeric foam substrate.

In accordance with a third embodiment of the present invention, a system for forming a composite structure is provided, comprising: (1) a platform member; (2) a conveyor belt system in physical cooperation with the platform member; (3) a latex material delivery system in fluid communication with the platform member; and (4) at least one latex material source in fluid communication with the latex material delivery system.

In accordance with a fourth embodiment of the present invention, a method for forming a composite structure is provided, comprising: (1) providing a polymeric foam substrate; (2) providing a latex material; and (3) applying the latex material to at least a portion of a surface of the polymeric foam substrate.

A more complete appreciation of the present invention and its scope can be obtained from the following detailed description of the invention, the drawings, and the appended claims.

### BRIEF DESCRIPTION OF THE DRAWINGS

The present invention will become more fully understood from the detailed description and the accompanying drawings, wherein:

FIG. 1 is a perspective view of a product made in accordance with one embodiment of the present invention;

FIG. 2 is a plan view of a foam base made in accordance with the general teachings of the present invention;

FIG. 3 is an end view of a foam base made in accordance with the general teachings of the present invention;

FIG. 4A is a schematic view of a coating method in accordance with the general teachings of the present invention;

FIG. 4B is a schematic view of a coating method in accordance with an alternative embodiment of the present invention; and

FIG. 5 is a schematic view of the operation of a produce drying method and assembly in accordance with one embodiment of the present invention.

The same reference numerals refer to the same parts throughout the various Figures.

### DETAILED DESCRIPTION OF THE PREFERRED EMBODIMENTS

While the present invention will be described more fully hereinafter, it is to be understood at the outset that persons of ordinary skill in the art may modify the invention herein described while still achieving the favorable results of this invention. Accordingly, the description that follows is to be understood as being a broad teaching disclosure directed to persons of skill in the appropriate arts, and not as limiting upon the present invention.

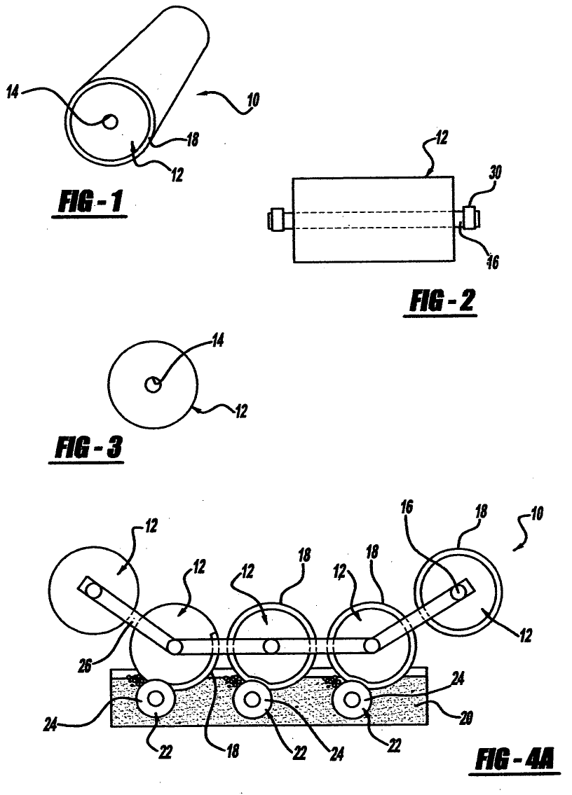

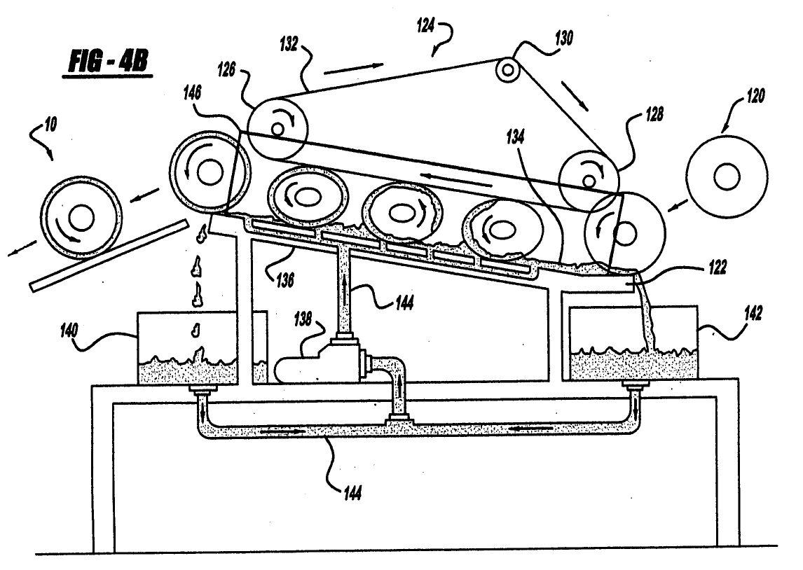

The preferred embodiment of the present invention relates to polyurethane foam impregnated with latex as more fully described below. FIG. 1 shows one form or product of the impregnated polyurethane foam, generally indicated at 10. As shown, the foam product 10 generally comprises a cylindrical base, generally indicated at 12. The cylindrical base 12 can have any axial length, depending on the desired use of the product 10. The generally cylindrical base 12 includes an area defining an inner opening 14 (e.g., a bore or through bore). Preferably, the inner opening 14 extends along the axial length of the base 12. Without being bound to a particular theory of the operation of the present invention, it is intended that the opening 14 is for receiving a shaft 16. This cylindrical shape of the base 12 is particularly useful for one application of the present invention as a part of a produce (e.g., fruit and vegetable) drying machine.

The base 12 preferably includes a latex coating 18 thereon. The latex coating 18 may be impregnated into the base 12 as is more fully set forth below. Alternatively, the latex coating 18 may comprise a latex layer 18 that is formed separately using a foaming process as set forth above, then disposed or otherwise applied over the base 12 and secured thereabout.

The cellular foam base 12 material is preferably a polymeric material such as a foam organic plastic. In accordance with a preferred embodiment of the present invention, the cellular foam base 12 material is hydrophilic. The air pockets, which comprise the cells, can be open or closed. Examples of acceptable polymers employed in the foaming industry are, without limitation, polyurethane, ethylene/vinyl acetate (EVA) copolymer, latex, polyethylene, polypropylene, butyl, silicone, cellulose acetate, neoprene, epoxy, polystyrene, phenolic, polyvinyl chloride (PVC), and other related polymers. The forming of the plastic material is performed in any known manner.

The latex composition can be comprised of a styrene-butadiene, nitrile-butadiene, natural rubber, or any combination thereof. The latex composition may be modified in a known manner for hydrophilic characteristics to aid in water uptake of the finished composite product. Suitable materials for the latex coatings include, without limitation, styrene-butadiene rubber (SBR), nitrile-butadiene rubber (NBR), or natural latex may be incorporated to compose the latex component. The latex coating is typically formulated in emulsion chemistry, which can range from no-gel to gel methods (which may include sodium silica fluoride, ammonium acetate, and other gelling compounds). The preferred embodiment of the present invention utilizes the no-gel methodology.

In order to manufacture a composite sponge foam product 10 according to the present invention, the foam base 12 is formed using any known process. The foam base 12 can be directly formed into the desired shape or can be cut into the desired shape, such as by die cutting. Preferably the foam base 12 includes open cells.

The polyurethane foam base 12 is preferably squeezed by mechanical force into the uncured no-gel latex formulation emulsion. One such effective no-gel latex formulation is composed of 83.64 parts BASF Butonal NS104, 6.76 parts sulfosuccinimate soap, 1.19 parts 10% potassium hydroxide solution, 7 parts BASF cure paste 590, 0.99 parts sodium lauryl sulfate, and 0.42 parts dye.

As shown schematically in FIG. 4A, the uncoated foam base 12 is preferably moved into a latex bath 20 containing at least one contact member, generally indicated at 22. The contact members preferably comprise a series of rollers 24 disposed at a predetermined position in the latex bath 20. The intended purpose of the rollers 24 is to engage the foam base 12 and provide a force to squeeze the foam base 12. The rollers 24 may either rotate or remain fixed.

As is shown, a track 26 is provided. The foam base 12 is preferably placed on a shaft 16 having rollers 30 thereon. The rollers 30 are preferably placed in the track 26. A suitable drive mechanism, not shown, preferably moves the shaft 16 along the track 26. Since the uncured latex emulsion formulation is fluid, the squeezing force of the rollers 30 preferably causes uptake of the formulation into the cells of the polyurethane foam base 12, which may or may not fully penetrate the foam, but typically partially penetrates several millimeters depth beyond the surface of the foam base 12, as shown in FIGS. 1, 4A and 4B. It will be appreciated that the foam base 12 may pass over several rollers 24 in order to apply the latex coating 18 over the desired amount of surface of the base 12.

Further, the end edges of the foam base 12 preferably include a latex coating thereon, as best seen in FIG. 1. This is particularly beneficial, especially when more than one product 10 is placed adjacent one on, for example, a produce drying machine. This latex impregnated base 12 is preferably placed in a convection or radio frequency (RF) oven to first remove water. The latex coating 18 is then cured by heat or time exposure. This produces a durable, but porous latex coating 18 on the foam base 12. With the latex hydrophilically formulated, uptake of water becomes even greater.

When the product 10 is dried and cured, the latex coating 18 typically penetrates below the surface of the foam base 12 and is coated or soaked in such a fashion to maintain porosity of the base polyurethane foam base 12. This allows water or other fluids to penetrate through the foam base 12 to the interior of the polyurethane foam. The outer layer of latex coating 18 preferably provides durability and hydrophilic character.

It will be appreciated that, while in the preferred embodiment, the latex coating 18 maintains the porosity of the foam base 12, it does not necessarily have to. In other words, the latex coating 18 may be applied in such a manner that the exterior porosity of the foam base is not maintained.

As shown schematically in FIG. 4B, an alternative apparatus is shown for producing the product 10 of the present invention, in accordance with an alternative embodiment of the present invention. In this embodiment, the uncoated foam base 120 is preferably placed onto a platform 122 in such a manner so as to contact at least a portion of a conveyor belt system 124. The platform 122 is preferably slanted or angled, the purpose of which will be explained herein.

The conveyor belt system 124 preferably includes at least two rollers 126, 128, respectively, and an optional tensioning roller 130, wherein a belt member 132 is moved in response to relative rotation of the respective rollers. The rollers 126, 128, respectively, preferably rotate in a counterclockwise direction, thus causing the uncoated foam base 120 to move in counter-clockwise direction. However, it is envisioned that an opposite orientation may be used to practice the present invention, as well.

As the uncoated foam base 120 moves along the platform 122, latex material 134, preferably in liquid form, is brought into contact with at least a portion of the surface of the uncoated foam base 120. The latex material 134 is preferably disposed on at least a portion of a surface of the platform 122 by an optional manifold system 136 that is in fluid communication with a pump system 138. The pump system 138 is preferably in fluid communication with at least one, and more preferably at least two latex material reservoirs 140, 142, respectively. A conduit system 144 preferably provides fluid communication between the manifold system 136, pump system 138, and latex reservoirs 140, 142, respectively.

Because the latex material 134 may have a tendency to flow or drip due to the slanted orientation of the platform 122, an optional sidewall system 146 is preferably used to channel the latex material into either latex reservoir 140, 142, respectively. In this manner, the excess latex material 134 may be recycled and reused to coat additional amounts of uncoated foam base 120.

As the foam base 120 proceeds along the conveyor belt system 124, additional portions of the surface thereof are exposed to the latex material 134, allowing more of the surface of the foam base 120 to become coated with the latex material. When the foam base 120 exits the conveyor belt system 124, the surface of the foam base 120 is preferably completed coated with the latex material 134 to form the product 10 of the present invention. The product 10 can then be transported by any number of suitable methods (e.g., additional conveyor belt/roller systems) for further processing, such as drying, curing, and the like.

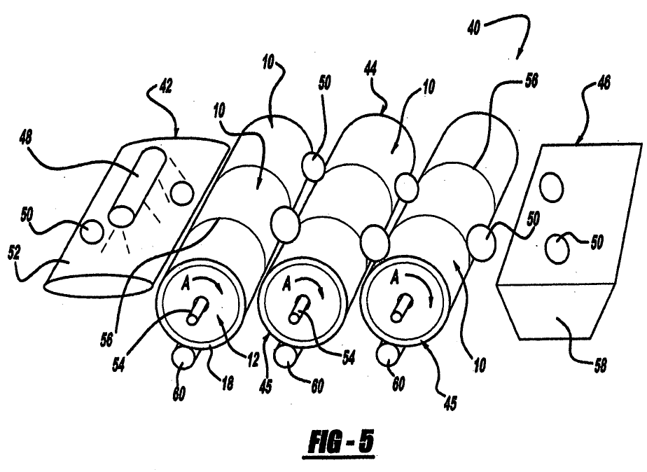

A drying apparatus for drying produce, such as fruits and vegetables, is generally shown at 40 in FIG. 5. FIG. 5 is a schematic representation of the drying apparatus 40. Generally, the drying apparatus 40 includes a washing section, generally indicated at 42, a drying section, generally indicated at 44, and a collection section, generally indicated at 46.

The washing section 42 includes a sprayer 48 that washes produce 50. The produce 50 may be conveyed on a conveyor 52. The conveyor 52 preferably moves the produce 50 to the drying section 44. The drying section 44 preferably comprises a series of roller assemblies 45. The roller assemblies 45 preferably include at least one of the foam products 10 made in accordance with the present invention. The roller assemblies 45 also preferably include a shaft 54. As is seen, the generally cylindrical foam bases 12 having the coating 18 thereon are placed on the shaft 54. As shown in FIG. 5, a series of three of such products 10 are shown on each shaft 54. It will be appreciated that any number of products 10 may be placed adjacent one another on the shaft 54. By having the latex coating 18 penetrate the cells, and particularly at the end edges thereof, the seams 56 between adjacent products 10 are strengthened.

Each of the products 10 are preferably rotatable with the shaft 54. The produce 50 is preferably conveyed to the first of the roller assemblies 45. The shaft 54 and products 10 thereon preferably rotate in the direction of the arrow A, causing the produce 50 to move to the next roller assembly 45 in the drying section 44. Any number of roller assemblies 45 can be used in the drying section 44. As shown, three such roller assemblies 45 are used. Under each of the roller assemblies 45 in the drying section 44, is a contact member 60. The contact member 60 preferably engages the latex coated surface 18 to provide a squeezing action on the product 10. This squeezing action preferably removes excess water from the product 10.

The washed produce 50 from the washing section 42 is preferably conveyed through the drying section 44 where the water on the produce 50 is absorbed into the products 10. The produce 50 continues to dry as it passes through the drying section 44. Upon exiting the drying section 44, the produce 50 is collected in the collection section 46. The collection section 46 may comprise bins 58 or a platform from which the produce 50 can be manually packed.

Use of the product as part of a drying assembly 40 for produce is only one potential use of the products 10 in accordance with the present invention. Similarly, while the products 10 are shown to be generally cylindrical, it will be appreciated that the products 10 can take any configuration within the scope of the present invention. Similarly, one or more sides of the product 10 may be coated with the latex coating 18. In a cylindrical shape, it may also be desirable to coat the inner opening 14 with latex material.

The foregoing description is considered illustrative only of the principles of the invention. Furthermore, because numerous modifications and changes will readily occur to those skilled in the art, it is not desired to limit the invention to the exact construction and process shown as described above. Accordingly, all suitable modifications and equivalents that may be resorted to that fall within the scope of the invention as defined by the claims that follow.

What is claimed is:

1. A composite structure, comprising:
a polymeric foam substrate; and
a latex layer formed on at least a portion of a surface of the polymeric foam substrate, wherein the latex layer infiltrates into at least a portion of a subsurface layer of the polymeric foam substrate.

2. The invention according to claim 1, wherein the composite structure is substantially cylindrical.

3. The invention according to claim 1, wherein the polymeric foam substrate includes an area defining an opening extending axially therethrough.

4. The invention according to claim 3, wherein the opening is operable to receive an axle member.

5. The invention according to claim 1, wherein the polymeric foam substrate is comprised of a hydrophilic material.

6. The invention according to claim 1, wherein the latex layer is comprised of a hydrophilic material.

7. The invention according to claim 1, wherein the polymeric foam substrate is comprised of a material selected from the group consisting of polyurethanes, ethylene/vinyl acetate copolymers, latexes, polyethylenes, polypropylenes, butyl-containing compounds, silicones, cellulose acetates, neoprenes, epoxies, polystyrenes, phenolic-containing compounds, polyvinyl chlorides, and combinations thereof.

8. The invention according to claim 1, wherein the latex layer is comprised of a material selected from the group consisting of styrene-butadienes, nitrile-butadienes, natural rubbers, natural latexes, and combination thereof.

9. The invention according to claim 1, wherein the latex layer is applied to the polymeric foam substrate in a substantially liquid form.

10. The invention according to claim 1, wherein the latex layer is allowed to substantially cure after being applied to the polymeric foam substrate.

11. A composite structure, comprising:
a polymeric foam substrate; and
a latex layer disposed on at least a portion of a surface of the polymeric foam substrate.

12. The invention according to claim 11, wherein the composite structure is substantially cylindrical.

13. The invention according to claim 11, wherein the polymeric foam substrate includes an area defining an opening extending axially therethrough.

14. The invention according to claim 13, wherein the opening is operable to receive an axle member.

15. The invention according to claim 11, wherein the polymeric foam substrate is comprised of a hydrophilic material.

16. The invention according to claim 11, wherein the latex layer is comprised of a hydrophilic material.

17. The invention according to claim 11, wherein the polymeric foam substrate is comprised of a material selected from the group consisting of polyurethanes, ethylene/vinyl acetate copolymers, latexes, polyethylenes, polypropylenes, butyl-containing compounds, silicones, cellulose acetates, neoprenes, epoxies, polystyrenes, phenolic-containing compounds, polyvinyl chlorides, and combinations thereof.

18. The invention according to claim 11, wherein the latex layer is comprised of a material selected from the group consisting of styrene-butadienes, nitrile-butadienes, natural rubbers, natural latexes, and combination thereof.

19. The invention according to claim 11, wherein the latex layer infiltrates into at least a portion of a subsurface layer of the polymeric foam substrate.

20. The invention according to claim 11, wherein the latex layer is disposed on the polymeric foam substrate in a substantially liquid form.

21. The invention according to claim 11, wherein the latex layer is allowed to substantially cure after being disposed on the polymeric foam substrate.

22. A system for forming a composite structure, comprising:
a platform member;
a conveyor belt system in physical cooperation with the platform member;
a latex material delivery system in fluid communication with the platform member; and
at least one latex material source in fluid communication with the latex material delivery system.

23. The invention according to claim 22, wherein the platform member is angled.

24. The invention according to claim 22, wherein the conveyor belt system comprises at least one roller member and a belt member.

25. The invention according to claim 22, wherein the latex material delivery system comprises a pump system.

26. The invention according to claim 22, wherein the latex material delivery system comprises a manifold system.

27. The invention according to claim 22, wherein the conveyor belt system is operable to receive a polymeric foam substrate.

28. The invention according to claim 27, wherein the conveyor belt system is operable to manipulate the polymeric foam substrate so as to cause the latex material to adhere to a surface thereof.

29. The invention according to claim 27, wherein the latex material is applied to the polymeric foam substrate in a substantially liquid form.

30. The invention according to claim 27, wherein the latex material is allowed to substantially cure after being applied to the polymeric foam substrate.

31. A method for forming a composite structure, comprising:
providing a polymeric foam substrate;
providing a latex material; and
applying the latex material to at least a portion of a surface of the polymeric foam substrate.

32. The invention according to claim 31, wherein the composite structure is substantially cylindrical.

33. The invention according to claim 31, wherein the polymeric foam substrate includes an area defining an opening extending axially therethrough.

34. The invention according to claim 33, wherein the opening is operable to receive an axle member.

35. The invention according to claim 31, wherein the polymeric foam substrate is comprised of a hydrophilic material.

36. The invention according to claim 31, wherein the latex material is comprised of a hydrophilic material.

37. The invention according to claim 31, wherein the polymeric foam substrate is comprised of a material selected from the group consisting of polyurethanes, ethylene/vinyl acetate copolymers, latexes, polyethylenes, polypropylenes, butyl-containing compounds, silicones, cellulose acetates, neoprenes, epoxies, polystyrenes, phenolic-containing compounds, polyvinyl chlorides, and combinations thereof.

38. The invention according to claim 31, wherein the latex material is comprised of a material selected from the group consisting of styrene-butadienes, nitrile-butadienes, natural rubbers, natural latexes, and combination thereof.

39. The invention according to claim 31, wherein the latex material infiltrates into at least a portion of a subsurface layer of the polymeric foam substrate.

40. The invention according to claim 31, wherein the latex material is disposed on the polymeric foam substrate in a substantially liquid form.

41. The invention according to claim 31, wherein the latex material is allowed to substantially cure after being disposed on the polymeric foam substrate.
